(19) United States
(12) Patent Application Publication
(10) Pub. No.: US 2003/0052629 A1
(43) Pub. Date: Mar. 20, 2003

(54) Control circuit for a DC brushless motor

(76) Inventor: Hsin-Mao Hsieh, Pingtung City (TW)

Correspondence Address: Thorp Reed & Armstrong, LLP, One Oxford Centre, 301 Grant Street, 14th Floor, Pittsburgh, PA, 15219-1425, US

(21) Appl. No.: 09/951,746

(22) Filed: Sep. 14, 2001

(51) Int. Cl. H02P 1/18

(52) U.S. Cl. 318/254

(57) ABSTRACT

A control circuit for a brushless motor has a power conversion unit having a rectifier connected to a power source to convert input AC power to DC power and a filter having an output terminal connected to coils of the motor to provide converted DC power to the coils, a Hall element to detect phase changes in the coils of the motor and then output a signal, wherein the Hall element has an input terminal connected to the power conversion unit; and a driver IC having an input terminal connected to the Hall element for receiving the output signal from the Hall element and output terminals respectively connected to the coils to control operation of the coils.

### BACKGROUND OF THE INVENTION

1. Field of the Invention

The present invention relates to a control circuit, and more particularly to a controlling circuit for a DC brushless motor. The control device includes an AC/DC converter so that the brushless motor can be driven directly by an AC power source.

2. Description of Related Art

Currently, DC brushless motors are quite popular for driving ventilation fans particularly in electronic equipment. With a Hall element, a conventional control circuit is able to detect the phase change of coils inside the motor so that the control circuit can provide a suitable signal to the driver IC to continuously drive the motor. To make the motor have a higher rotation speed, a higher input DC voltage is required to provide the necessary power to drive the motor. To accomplish this objective, a voltage booster is added to the conventional control circuit so that the DC voltage is increased. However, the addition of the voltage booster increases the cost of the control circuit.

To overcome the shortcomings, the present invention tends to provide an improved control circuit to mitigate and obviate the aforementioned problems.

### SUMMARY OF THE INVENTION

The primary objective of the invention is to provide a control circuit to boost the working voltage for a DC brushless motor without increasing the cost.

To accomplish the objective, the control circuit includes an AC-DC power conversion unit, a Hall element and a driver IC. The AC-DC power conversion unit converts AC power to DC power. The Hall element detects the phase change in the coils inside the motor. The driver IC is connected to the coils by means of switches and operates the coils.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the control circuit for a DC brushless motor in accordance with the present invention, and

FIG. 2 is a circuit diagram of the control circuit for a DC brushless motor in accordance with the present invention.

### DETAILED DESCRIPTION OF THE PREFERRED EMBODIMENT

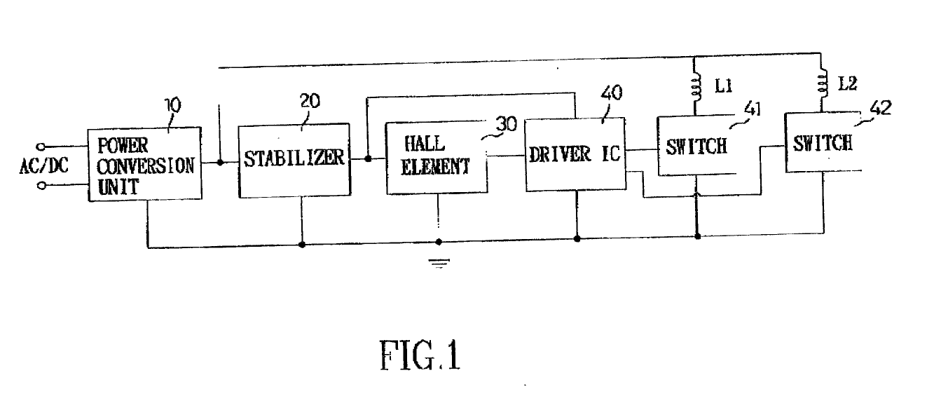

With reference to FIG. 1, the control circuit for a DC brushless motor in accordance with the present invention is connected to coils (L1, L2) (two coils are shown in this embodiment) of the motor (not shown).

The control circuit includes a power conversion unit (10), a stabilizer (20), a Hall element (30) and a driver IC (40).

The power conversion unit (10) is connected to a power source to convert input AC power to DC power to be provided to the coils (L1, L2). The power conversion unit (10) has a rectifier (11) and a filter (12), wherein the rectifier (11) is a full wave rectifier and the filter (12) is a capacitor C1 connected between the output of the full wave rectifier and ground.

The stabilizer (20) is connected to an output terminal of the power conversion unit (10) to provide a stable voltage. The stabilizer (20) includes a resistor R1 and Zener diode Z1.

The Hall element (30) detects phase changes in the coils (L1, L2) of the motor and then outputs a signal. The Hall element (30) is a Hall IC.

The driver IC (40) has an input terminal connected to the Hall element (30) and output terminals respectively connected to the coils (L1, L2) by means of switches (41, 42) to control the on/off state of the switches (41, 42) to operate the coils (L1, L2). The switches (41, 42) are Metal Oxide Semiconductor Field Effect Transistors (MOSFET) (Q, Q2).

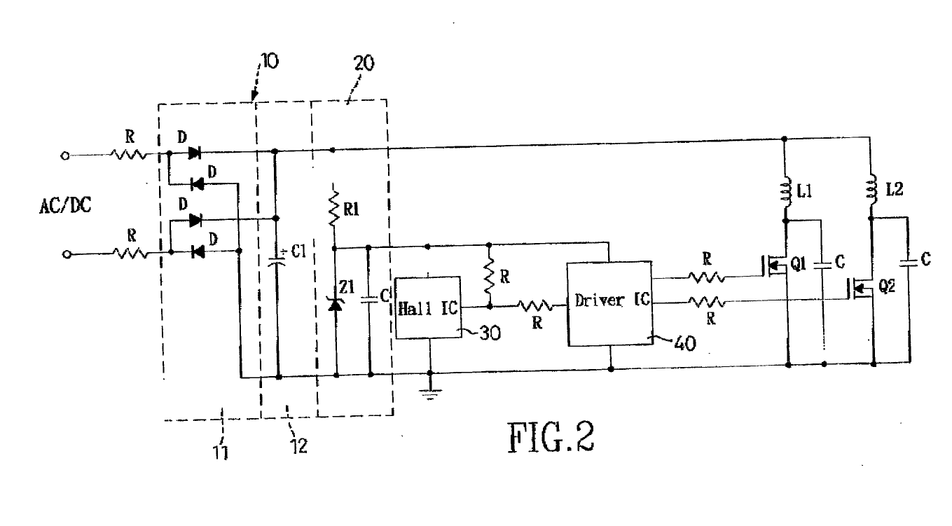

With reference to FIG. 2, the power conversion unit (10) is connected to a power source. By means of the rectifier (11), a DC current is output to the filter (12) which then outputs a working DC current to the coils (L1, L2). The working voltage of the Hall element (30) and the driver IC (40) is provided through the Zener diode Z1. After the Hall element (30) detects the phase changes of the coils (L1, L2), the Hall element (30) outputs a signal to the driver IC (40) so that the driver IC (40) is able to control the on/off state of the switches (Q1, Q2) to alternately operate the coils (L1, L2).

The control circuit of the present invention is able to connect directly to a DC power source, which still accomplishes the same purpose of driving the coils (L1, L2).

With the power conversion unit (10), a boost in the motor working voltage is accomplished so that the operation speed of the motor is increased. Without increasing the cost of the control circuit, the operation speed of the motor is easily fulfilled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A control circuit for a brushless motor, the control circuit comprising:
a power conversion unit having a rectifier connected to a power source to convert input AC power to DC power and a filter having an output terminal connected to coils of the motor to provide the converted DC power to the coils;
a Hall element to detect phase changes in the coils of the motor and then output a signal, wherein the Hall element has an input terminal connected to the power conversion unit; and
a driver IC having an input terminal connected to the Hall element for receiving the output signal from the Hall element and output terminals respectively connected to the coils to control operation of the coils.

2. The control circuit claimed in claim 1, wherein the rectifier is a full wave rectifier and the filter is a capacitor connected between the full wave rectifier and ground.

3. The control circuit as claimed in claim 2 further comprising a stabilizer connected to an output terminal of the power conversion unit to provide a stable voltage to the coils.

4. The control circuit as claimed in claim 2, wherein the output terminals of the driver IC are respectively connected to the coils by means of switches to control operation of the coils.

5. The control circuit as claimed in claim 4, wherein the switches are metal oxide semiconductor field effect transistors.
